(19) United States
(12) Patent Application Publication
(10) Pub. No.: US 2011/0264751 A1
(43) Pub. Date: Oct. 27, 2011

(54) SYSTEM AND METHOD FOR A VIDEO EMAILING SERVICE

(76) Inventor: Lucas A. Jans, Bend, OR (US)

(21) Appl. No.: 13/091,321

(22) Filed: Apr. 21, 2011

Related U.S. Application Data
(60) Provisional application No. 61/326,533, filed on Apr. 21, 2010.

(51) Int. Cl. G06F 15/16; G06F 17/00

(52) U.S. Cl. 709/206; 715/202

(57) ABSTRACT

Systems and methods for creating, transmitting and receiving a video email. A user records a video for incorporation into a video email. The user logs into a video server and uses a video creation interface to record a video and define an email message in which to embed the video. The video may be stored on the video server and the message contents are passed to a messaging server. The messaging server downloads one or more frames of the recorded video and creates a still image using the one or more frames. The messaging server embeds the image into an email and includes the message contents to create a video email. The messaging server sends the video email to a recipient. The recipient receives the email and clicks on the one or more images. The recipient's computer launches a web browser that automatically plays the video from the video server.

### CROSS REFERENCE TO RELATED APPLICATIONS

This application claims the benefit of U.S. Provisional Application No. 61/326,533, filed on Apr. 21, 2010, the contents of which are hereby incorporated by reference in their entirety.

### BACKGROUND OF THE INVENTION

1. Field of the Invention

The present invention is directed generally to messaging systems and more particularly to systems and methods for providing a video emailing service.

2. Description of the Related Art

Electronic mail or “email,” refers to systems and methods for sending and receiving digital messages from a sending user or author to one or more recipients. Email systems operate globally across the Internet and other computer networks. Email systems are generally based on a model referred to as a “store-and-forward” model. Email servers accept, forward, deliver and store email messages. In this model, neither the users of an email system nor their computers are required to be online simultaneously. Rather, they only need to connect to an email server for as long as it takes to send or receive messages. In general, an email message consists of the message body (i.e., the contents) and the message header. The message header often contains control information, such as a sender's email address and one or more recipient addresses. Usually descriptive information is also added, such as a subject header field and a message submission date/time stamp. The message body may include text, images, attachments, and links to one or more websites.

### BRIEF DESCRIPTION OF THE SEVERAL VIEWS OF THE DRAWINGS

FIG. 1 is a block diagram illustrating a video emailing environment.

FIG. 2 is a flow diagram illustrating a process for defining a video email.

FIG. 3 is a flow diagram illustrating a process for finalizing the definition of a video email.

FIG. 4 is flow diagram illustrating a process for transmitting a video email.

FIG. 5 is a flow diagram illustrating a process for receiving and displaying a video email.

FIG. 6 is a display window illustrating a video creation user interface.

FIG. 7 is a display window illustrating a message creation user interface.

FIG. 8A illustrates a video template overlay image and a single frame of a video to be embedded into a video email.

FIG. 8B illustrates a video image file comprising the video template overlay image and the frame shown in FIG. 8A.

FIG. 9 is a display window illustrating a message body including a video image file.

FIG. 10 illustrates a video presentation webpage in accordance with an embodiment of the present invention.

FIG. 11 is a diagram illustrating a computer hardware and operating environment.

### DETAILED DESCRIPTION OF THE INVENTION

The present disclosure is directed to systems and methods for creating, transmitting and receiving a video email. As described below, the systems and methods of the present disclosure enable users to quickly and easily generate video content that can be distributed to one or more recipients. In general, a user records a video for incorporation into a video email. As an example, the video may be a marketing or informative presentation to customers or potential customers. A user of the system may log into a video server (e.g., via the Internet) and use a video creation interface to record a video and define an email message (or simply “email”) in which to embed the video. The video may be stored on the video server and the message contents are passed to a messaging server. The messaging server downloads one or more frames (e.g., a single frame) of the recorded video and creates a still image using the frames. The messaging server embeds the images into an email and includes the message contents to create a video email. The messaging server sends the video email to a recipient. The recipient receives the email and clicks on the one or more images. The recipient's computer launches a web browser that plays the video from the video server.

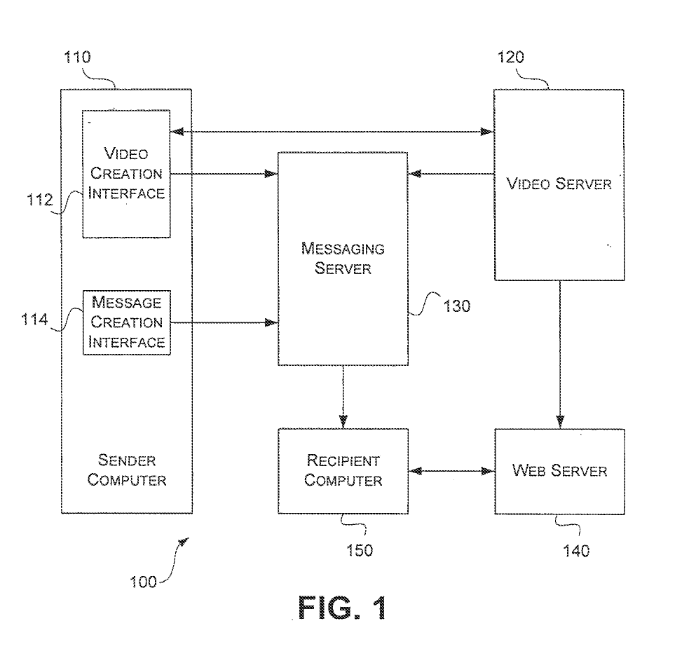

FIG. 1 illustrates a video emailing environment or system 100 having a sender computer 110, a video server 120, a messaging server 130, a web server 140, and a recipient computer 150. In some embodiments, some of the components of the video emailing environment 100 may be implemented on separate computers, while in other embodiments some of the components may be implemented on the same computer. For example, the sender computer 110 may function as a server that also includes the functionality of the video server 120, the messaging server 130, and the web server 140, or any other combination. The sender computer 110 includes a video creation interface 112 and a message creation interface 114. These interfaces may be displayed to a sending user as part of a single user interface, or as separate user interfaces. The video creation interface 112 couples to the video server 120 and the messaging server 130 through a suitable interface. The message creation interface 114 couples to the messaging server 120. The video server 120 couples to the messaging server 130 and the web server 140. The messaging server 130 couples to the video creation interface 112, the message creation interface 114, the video server 120 and the recipient computer 150. The web server 140 couples to the video server 120 and the recipient computer 150. The recipient computer 150 couples to the messaging server 130 and the web server 140.

The sender computer 110 is generally the computer operating by a user creating and sending a video email (“sending user”). The sending user operates the video creation interface 112 to record and design the video to be emailed. The video creation interface 112 may be coupled to a video camera to record the video. The sending user also operates the message creation interface 114 to create the email message in which the video is to be embedded. Through the message creation interface 114, the sending user can specify one or more recipients, create textual content, identify attachments, and design the look and feel of the video email.

The video server 120 may be a stand alone server or its functionality may be included within the sender computer 110. When implemented as a stand alone server, the video server 120 may be coupled to the sender computer 110 via a network, such as a local area network (“LAN”) or a wide area network (“WAN”), such as the internet. The video server 120 provides the functionality for creating, storing, and providing a video.

The messaging server 130 may also be a stand alone server or its functionality may be included within the sender computer 110. When implemented as a stand alone server, the messaging server 130 may be coupled to the sender computer 110 via a network, such as a LAN or a WAN. The messaging server 130 generally provides the functionality for creating and transmitting video emails.

The web server 140 may be a stand alone server or its functionality may be included within the sender computer 110. When implemented as a stand alone server, the web server 140 may be coupled to the sender computer 110 via a network, such as a LAN or a WAN. The web server 140 hosts one or more websites that allow recipients of the video email to view and play the recorded video. The web server 140 may include functionality to dynamically generate the website used to display the video.

The recipient computer 150 may be any standard computer or terminal from which a recipient of a video email message may receive the video email from the messaging server 130. Examples of the recipient computer 150 include desktop computers, notebook computers, mobile phones, tablet computers, and the like. The recipient computer 150 may also enable a recipient to use an internet browser to access a website hosted on the web server 140 and playback the video. The recipient computer 150 may be coupled to the messaging server 130 and the web server 140 via a network, such as a LAN or a WAN.

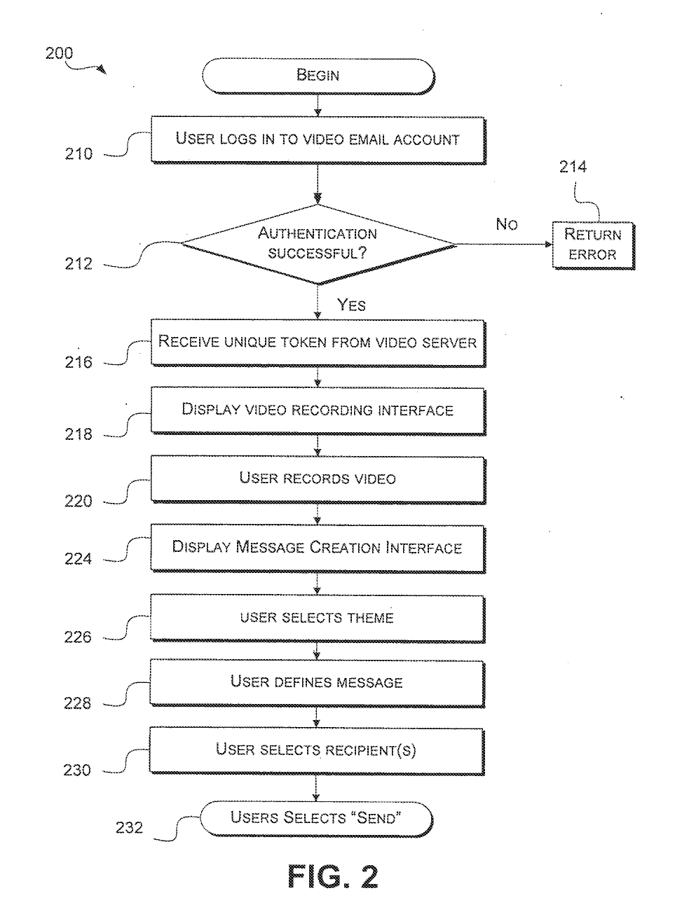

FIGS. 2-5 illustrate processes of defining, finalizing, transmitting and receiving a video email using the components of the video emailing environment or system 100 described above. Although shown as a sequence of steps, the particular order the steps are executed in is unimportant. Further, events illustrated as separate events may take place at the same time or as part of a single event.

FIG. 2 illustrates a process 200 for defining a video email. The process 200 begins in block 210 when a sending user operates the video creation interface 112 to login to a video email account on the messaging server 130. This may include entering authentication information, such as a user name and password. In block 212 the messaging server 130 attempts to authenticate the user based on the received authentication information. If the authentication is not successful, the process 200 continues to block 214 where an error message is returned. If the authentication is successful, the process 200 continues to block 216. In block 216, the messaging server 130 logs into the video server 120 and receives a unique token, which is assigned each time a user is creating a new video email. Each video email is associated with a single token. The messaging server 130 then passes that token to the video creation interface 112. In block 218, the video creation interface 112 displays a video recording interface on the sender computer 110. The video creation interface 112 provides the user interface that enables the sending user to record and/or edit a video.

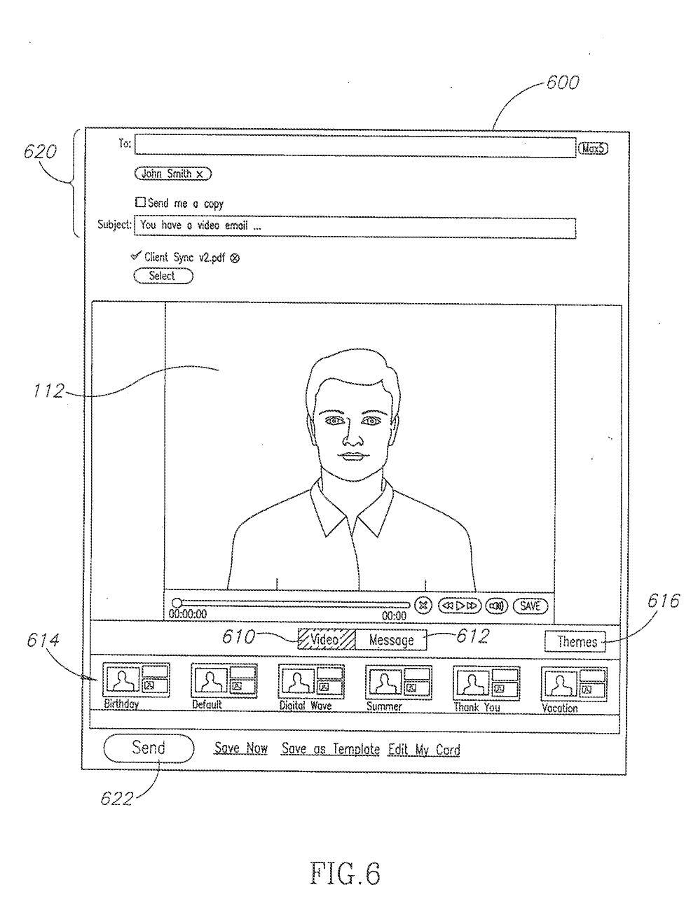

FIG. 6 is a display window 600 illustrating an example of the video creation interface 112. The video creation interface 112 may be initially displayed and may be selected by a user by clicking on a “Video” icon 610 of the display window 600. Although the video creation interface 112 is displayed on the sender computer 110, the underlying software that records and processes the video may be located on the video server 120. In block 220 of FIG. 2, the user records a video by, for example, using a video camera coupled to the sender computer 110. In block 224, the sender computer 110 displays a message creation interface 114 when a user clicks on a “Message” icon 612.

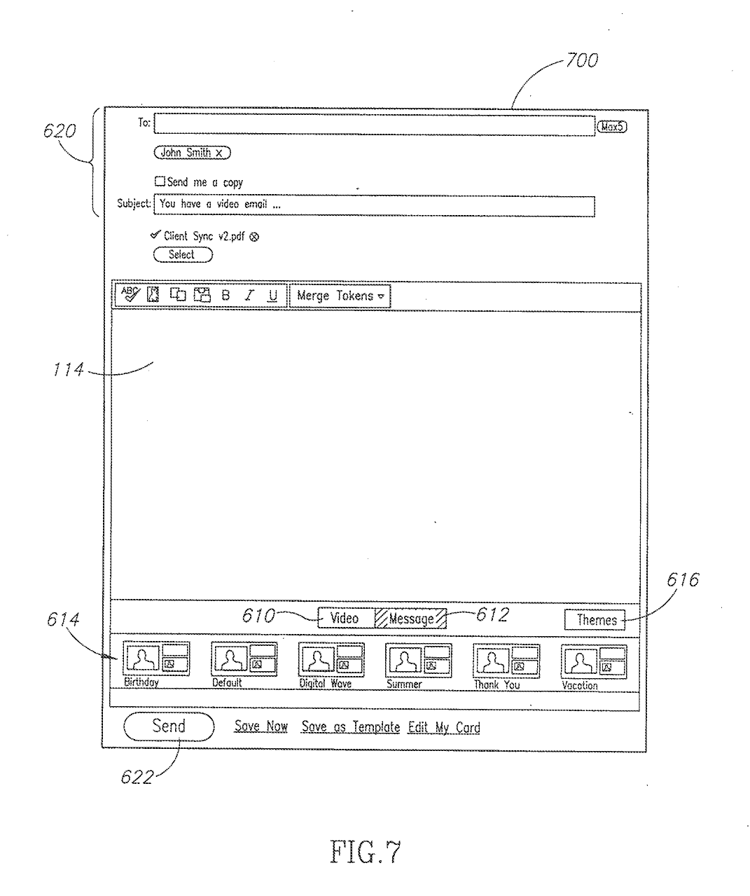

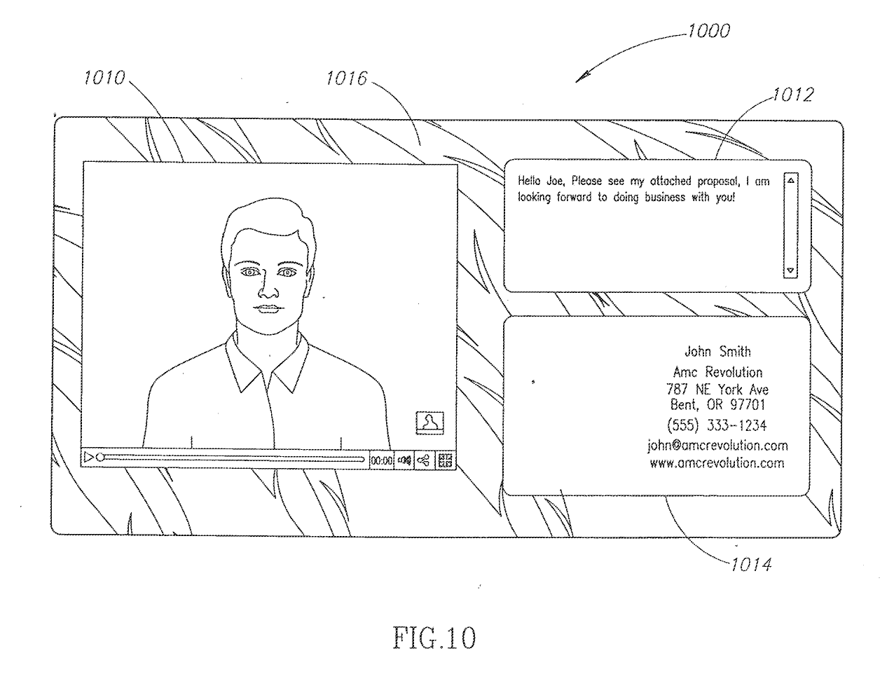

FIG. 7 is a display window 700 illustrating an exemplary message creation user interface 114. The message creation interface 114 provides a user interface that enables a user to define the email message in which the video will be embedded. In block 226 of FIG. 2, the user selects a message theme 614 (e.g., by first clicking on a “Themes” icon 616). Message themes 614 may include preassembled sets of message attributes, such as font, color, design layouts and relative positioning of text, images, and the embedded video. In the embodiment shown in FIG. 6, the message themes 614 include Birthday, Default, Digital Wave, Summer, Thank You, and Vacation themes. As an example, the Vacation them may include background images of palm trees or other features associated with vacations (see the background image 1016 shown in FIG. 10). In other embodiments, users may be able to create customized message themes. In block 228, the user defines an email message using the message creation user interface 114 (see FIG. 7). The email message may include text, images and attachments, in addition to the embedded video. In block 230, the user inputs the names and email addresses of the recipients of the video email, as well as a subject line, into a text input interface 620 (see FIGS. 6 and 7). The user may select the recipients from a private address book of the user or a shared address book made available to the user. The user may input a single recipient or multiple recipients. In block 232, the process 200 completes when the user selects a send option 622 (see FIGS. 6 and 7) on the message creation interface 114.

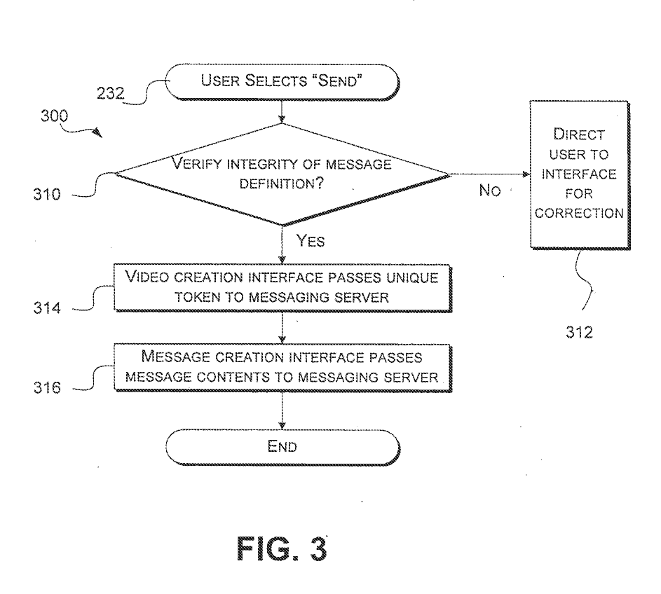

FIG. 3 illustrates a process 300 for finalizing the definition of a video email. The process 300 begins at block 310 where the integrity of the message definition is verified. Here, the message creation interface 114 verifies that the user has properly defined all of the components of the video email. If the message creation interfaces 114 detects an error in the message definition, the process 300 flows to block 312 where the user is directed to the proper portion of the message creation interface to correct the error. If the message creation interface does not detect any errors in the message definition, the process 300 flows to block 314. In block 314, the video creation interface 112 passes the unique token associated with the video email to the messaging server 130. In block 316, the message creation interface 114 passes the message definition, including the message contents, to the messaging server 130.

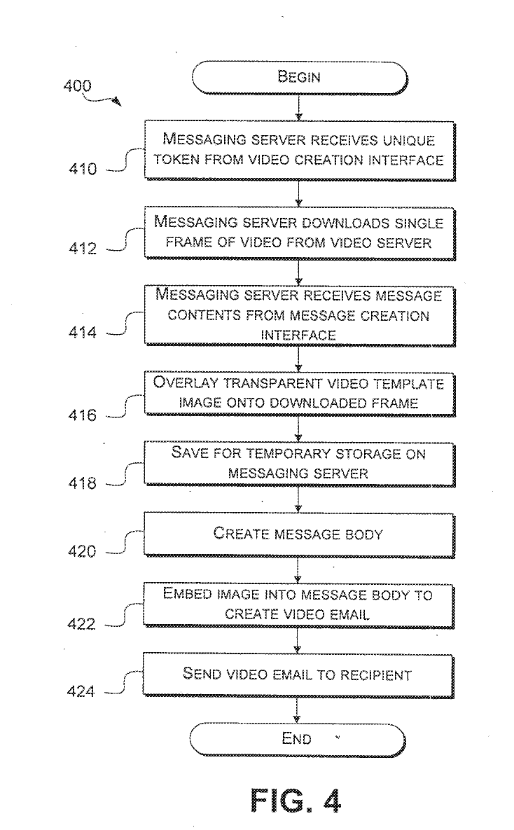

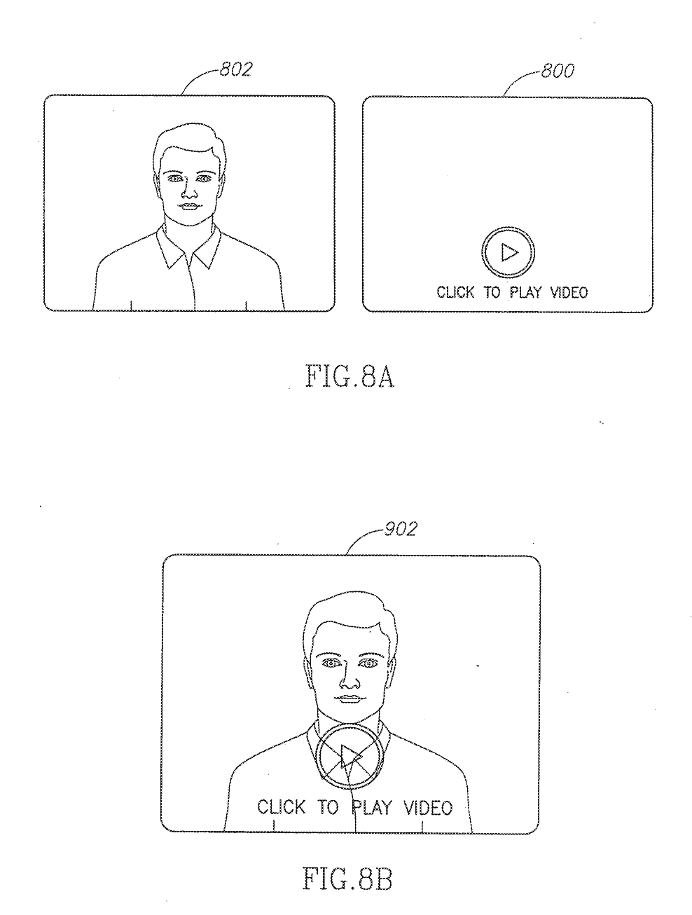

FIG. 4 illustrates a process 400 for transmitting a video email. The process 400 begins at block 410 when the messaging server 130 receives the unique token from the video creation interface 112. In block 412, the messaging server 130 downloads a single frame 802 (see FIG. 8A) of video from the video server 120. In other embodiments, the messaging server 130 may download more than a single frame. For example, the messaging server 130 may download the first frame of the video stored on the video server 120 in association with the unique identifier. In other embodiments, the messaging server 130 may download a user-specified frame of the video (e.g., a frame that is representative of the contents of the video). In this way, the messaging server 130 is not required to download and store a copy of the entire video, only the single frame 802. In block 414, the messaging server 130 receives the message definition from the message creation interface 114, which includes the message contents.

As illustrated in FIGS. 8A and 8B, the messaging server 130 overlays a video template image 800 onto the downloaded frame 802, block 416. The video template image 800 may include portions that are opaque, semi-transparent, or transparent. The video template image 800 may be a semi-transparent image that includes operational features, such as a play button or the words “Click here to Play Video Email,” to provide an indication to a recipient to click the image to initiate a video playback. In some examples, the video template overlay image 800 may be included within the message definition received from the message creation interface 114. In other examples, the video template image 800 may be standardized and stored on the messaging server 130.

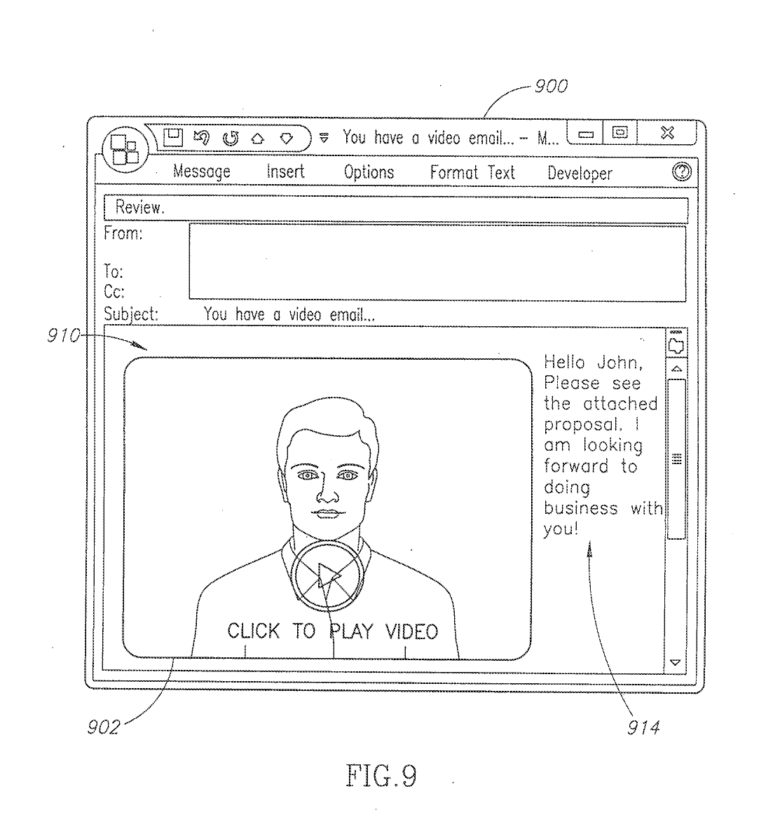

In block 418, the messaging server 130 saves an image file 902 (see FIG. 8B and FIG. 9) that results from placing a copy of the video overlay template image 800 onto the downloaded video frame 802. FIG. 9 illustrates a video email message display window 900 including an exemplary video image file 902 that includes the video template overlay image 800 shown in FIG. 8A positioned over the downloaded video frame 802. In some examples, the video image file 902 may be stored only temporarily and deleted after the video email is sent. In this manner, storage utilization is minimized on the messaging server 130.

In block 420, the messaging server 130 creates the message body 910 (see FIG. 9) in the display window 900. The message body 910 may be created in accordance with the message definition received from the message creation interface 114. The message body 910 may include text 914, images, attachments, or other content to be included in the video email. In block 422, the messaging server 130 embeds the video image file 902 into the message body 910 to create the video email. The actual video image file (e.g., the video image file 902 of FIG. 9) is attached to the message as a “Linked Resource,” a form of inline attachment. The body 910 of the message may reference this attachment so the recipient's computer 150 displays the video image file 902. By embedding the video image file 902 into the message body 910, the recipient computer 150 will automatically display the image file in the email without further input from the recipient, such as the need for the recipient to select a “display images” option. When the video image file 902 is embedded, a hyperlink is created in association with the video image file. The hyperlink provides a unique address identifier that can pass information to the video server 120. In block 424, the messaging server 130 transmits the video email to the recipients specified in the message definition (e.g., the recipients entered by the user into the text input interface 620 shown in FIGS. 6 and 7).

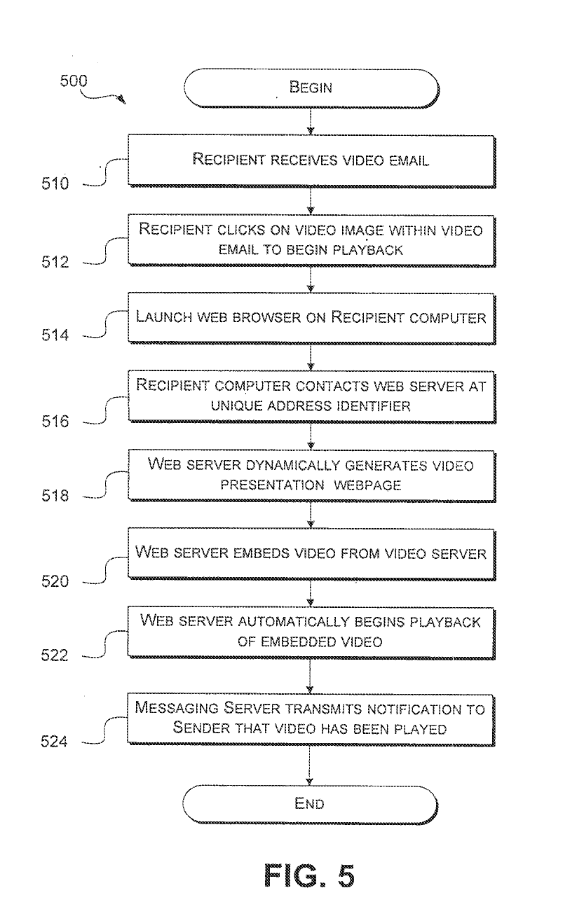

FIG. 5 illustrates a process 500 for receiving and displaying a video email. The process 500 begins at block 510 when a recipient receives a video email at the recipient computer 150. The message body and video image file are automatically displayed to the user (similar to the message body 910 shown in the display window 900 of FIG. 9). The video overlay 800 (see FIG. 8A) may provide to the recipient an indication that the image may be selected, such as by clicking it. In block 512, the recipient clicks on the video image file to begin playback. In block 514, the recipient computer 150 launches a web browser. In block 516, the recipient computer 150 contacts the web server 140 at the unique address identifier associated with the video image file. In block 518, the web server 140 begins the process of dynamically generating a video presentation webpage.

FIG. 10 illustrates an exemplary video presentation webpage 1000. The video presentation webpage 1000 may include an video interface 1010 to present the video. The video interface 1010 may include a portion for displaying the video as well as various controls for operating the playback of the video. The webpage 1000 may also include other information, such as a textual message 1012 and a virtual business card 1014, relating to the video, the sender of the video, or other information. The video presentation webpage also includes a background image 1016 resembling tropical leaves. As an example, the background image 1016 may be part of the Vacation theme described above. In block 520 of FIG. 5, the web server 140 embeds the video from the video server 120 by including HTML code that references the video server for access to the video and a video player. The code may include embedded, object and/or video HTML tags. In block 522, the web server 140 displays the video presentation webpage 1000 and automatically begins playback of the embedded video in the video interface 1010. Following playback of the video, in block 524 the messaging server 130 transmits a notification to the sending user that created and/or sent the video email that the video has been played back by the recipient. This notification may be transmitted upon each playback, or only upon the first playback.

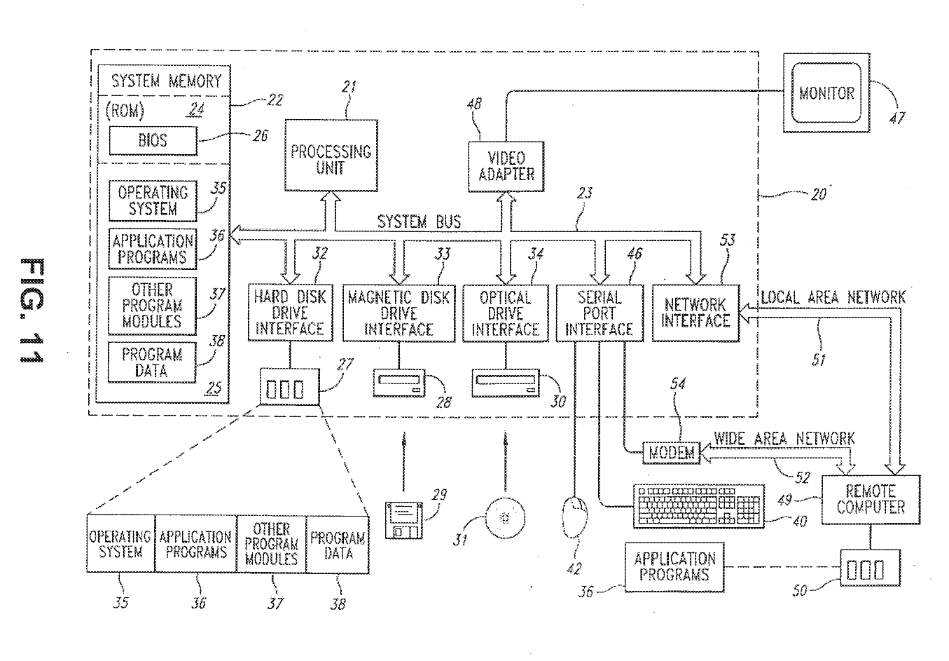

FIG. 11 is a diagram illustrating a computer hardware and operating environment. The description of FIG. 11 is intended to provide a brief, general description of suitable computer hardware and a suitable computing environment in which implementations may be practiced. Implementations are described in the general context of computer-executable instructions, such as program modules, being executed by a computer, such as a personal computer. Generally, program modules include function calls, routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 11 includes the computing device 20, which may be a general-purpose computing device of any type known in the art, including a processing unit 21, a system memory 22, and a system bus 23 that operatively couples various system components, including the system memory 22, to the processing unit 21. There may be only one or there may be more than one processing unit 21, such that the processor of computing device 20 comprises a single central-processing unit (CPU), or a plurality of processing units, commonly referred to as a parallel processing environment. The computing device 20 may be a conventional computer, a distributed computer, or any other type of computer.

The system bus 23 may include any bus structure including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 20, such as during start-up, is stored in ROM 24. The computing device 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 20. It should be appreciated by those skilled in the art that any type of computer-readable media, which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk drive 27, magnetic disk 29, optical disk 31, ROM 24, RAM 25, or other computer-readable media, including an operating system 35, one or more application programs 36, other program modules 37, and program data 38. The other program modules 37 may include one or more of the video creation interface 112, the message creation interface 114, the functionality provided by the video server 120, the functionality provided by the messaging server 130, the functionality provided by the web server 140, or the functionality provided by the recipient computer 150. Each of these has computer-executable instructions that when executed by the processing unit 21 cause the processing unit 21 to perform the functions described above.

A user may enter commands and information into the personal computing device 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computing device 20 may operate in a networked environment using logical connections to one or more remote computers, such as remote computer 49. These logical connections are achieved by a communication device coupled to or a part of the computing device 20 (as the local computer). Implementations are not limited to a particular type of communications device. The remote computer 49 may be another computing device substantially similar to computing device 20, a server, a router, a network PC, a client, a peer device or other common network node, and typically includes many or all of the elements described above relative to the computing device 20, although only a memory storage device 50 has been illustrated in FIG. 11. The logical connections depicted in FIG. 11 include a local-area network (LAN) 51 and a wide-area network (WAN) 52. Such networking environments are commonplace in offices, enterprise-wide computer networks, intranets, and the Internet.

When used in a LAN-networking environment, the computing device 20 is connected to the local network 51 through a network interface or adapter 53, which is one type of communications device. When used in a WAN-networking environment, the computing device 20 typically includes a modem 54, or any other type of communications device for establishing communications over the wide area network 52, such as the Internet. The modem 54, which may be internal or external, is connected to the system bus 23 via the serial port interface 46. In a networked environment, program modules depicted relative to the personal computing device 20, or portions thereof, may be stored in a remote memory storage device. It is appreciated that the network connections shown are exemplary and other means of and communications devices for establishing a communications link between the computers may be used.

The computing device 20 and related components have been presented herein by way of particular example and also by abstraction in order to facilitate a high-level view of concepts involved. The actual technical design and implementation may vary based on particular implementation while maintaining the overall nature of concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for providing a video emailing service, the system comprising:
a video server operative to receive and store a video from a video creation interface associated with a sender computer; and
a messaging server communicatively coupled to the video server and operative to receive message contents from a message creation interface associated with the sender computer, the messaging server being further operative to create a video email that comprises the message contents and a video image file having a link associated therewith that is operative to pass information to the video server, the messaging server being further operative to send the video email to a recipient computer.

2. The system of claim 1, further comprising a web server communicatively coupled to the video server and the messaging server, the web server being operative to generate a video presentation webpage that allows the video to be displayed on the recipient computer.

3. The system of claim 2, wherein the video presentation webpage comprises a message theme selected from a plurality of message themes by a user of the sender computer.

4. The system of claim 1, wherein the messaging server is further operative to download a frame of the video from the video server, and wherein the video image file comprises a video template image overlaid onto the frame of the video.

5. The system of claim 1, wherein the video server is operative to pass a unique token corresponding to a video email to the video creation interface, and wherein the video creation interface is operative to pass the unique token to the messaging server so that a particular video is associated with a particular video email.

6. A method for creating a video email, comprising:
receiving message content from a sender computer;
receiving a unique identifier from the sender computer, the unique identifier being associated with a video created by a user of the sender computer;
receiving a frame of the video;
creating a video image file using the frame of the video;
embedding the video image file and the message content into a message body; and
creating a link associated with the video image file that, when activated by a recipient of the video email, is operative to initiate playback of the video on a computer of the recipient.

7. The method of claim 6, further comprising:
sending the video email to the recipient specified by the user of the sender computer.

8. The method of claim 6, wherein creating the video image file comprises overlaying a video template image onto the frame of the video.

9. The method of claim 6, wherein the link comprises a hyperlink that provides a unique address identifier that can pass information to a video server storing the video when the hyperlink is clicked on by the recipient.

10. The method of claim 6, further comprising receiving a selection of a message theme from a plurality of selectable message themes that include preassembled sets of message attributes.

11. The method of claim 6, further comprising downloading the frame of the video from a video server storing the video.

12. The method of claim 6, wherein the unique identifier is received from a video creation interface of the sender computer and the message content is received from a message creation interface of the sender computer.

13. The method of claim 6, further comprising:
receiving information from the link in response to the recipient activating the link once the recipient has received the video email on a recipient computer;
generating a video presentation webpage associated with the video email;
embedding the video into the video presentation page; and
automatically initiating playback of the embedded video on a display of the recipient computer.

14. The method of claim 13, further comprising causing a web browser of the recipient computer to be launched.

15. The method of claim 6, further comprising transmitting a notification to the sender computer providing an indication that the video has been played.

16. The method of claim 6, wherein the video image file comprises a video template image having a semi-transparent image that includes a play button to provide an indication to the recipient to click the video image file to initiate playback of the video.

17. A method for creating a video email:
creating a video using a video creation interface;
creating message content associated with the video using a message creation interface;
inputting a recipient to whom the video email is to be sent; and
providing a request to a video emailing service to create the video email and send the video email to the recipient.

18. The method of claim 17, wherein the request to send the video email causes the video emailing service to:
create a video image file using a frame of the created video;
embed the video image file and the created email message into a message body to create the video email;
create a link associated with the video image file that is operative to pass information to a video server when activated by the recipient; and
send the video email to the recipient.

19. The method of claim 17, further comprising selecting a message theme from a plurality of selectable message themes.

20. The method of claim 17, further comprising receiving a notification from the video emailing service indicating that the video email has been played.
